(19) United States
(12) Patent Application Publication
(10) Pub. No.: US 2011/0208645 A1
(43) Pub. Date: Aug. 25, 2011

(54) VIRTUAL FARE CARD AND VIRTUAL FARE DEVICE

(75) Inventors: Christopher Lee Knauft, Bellingham, WA (US); David Wayne Andrews, Hampstead, NC (US); Timothy Cook, Carlsbad, CA (US); Mark Alan Summy, Santee, CA (US)

(73) Assignee: Cubic Corporation, San Diego, CA (US)

(21) Appl. No.: 12/962,917

(22) Filed: Dec. 8, 2010

Related U.S. Application Data
(60) Provisional application No. 61/307,813, filed on Feb. 24, 2010.

(51) Int. Cl. G06Q 50/00; G06Q 20/00; G06Q 40/00

(52) U.S. Cl. 705/39; 235/384; 235/380

(57) ABSTRACT

Embodiments of systems, methods, and machine-readable media are disclosed for enabling a uniquely-identifiable item as fare media in a transit system. Embodiments generally include collecting a unique identifier from the item, and sending the unique identifier, and other data, to a virtual fare device. The virtual fare device can use the unique identifier to access historical and/or other information associated with the unique identifier, calculate a fare, and/or update the information in a manner similar to how a physical fare device updates information on physical fare media, such as a stored-value card. The virtual fare device then can send data, such as priced transaction data including fare information, to other systems and/or servers of the transit system for further processing.

The present application claims benefit under 35 USC 119(e) of U.S. Provisional Application No. 61/307,813, filed on Feb. 24, 2010, entitled “Virtual Smart Card And Virtual Fare Device,” the entire contents of which are incorporated herein by reference for all purposes.

### BACKGROUND

As transit systems throughout the world continue to mature, so do the technologies that support them. Transit systems often use stored-value fare media, such as a transit fare card, that can store a value and historical information (e.g., trip history) on the media. Transactions within the transit system, such as entry to and/or exit from the transit system by a transit user, typically involve a fare device reading from and writing to this stored information. Stored-value fare media can enable quick transactions in the transit system, but can be both limited in the amount of information it can store and difficult to replace if lost.

Some transit systems can allow for fare media that do not store value and/or historical information. Enabling such fare media, however, can be difficult, especially for transit systems that have used stored-value fare media historically. It may require, for example, additional systems that can be difficult and expensive to integrate with existing systems for processing transactions.

### BRIEF SUMMARY

Embodiments of systems, methods, and machine-readable media are disclosed for enabling a uniquely-identifiable item as fare media in a transit system. Embodiments generally include collecting a unique identifier from the item, and sending the unique identifier, and other data, to a virtual fare device. The virtual fare device can use the unique identifier to access historical and/or other information associated with the unique identifier, calculate a fare, and/or update the information in a manner similar to how a physical fare device updates information on stored-value fare media, such as a transit fare card. The virtual fare device then can send data, such as priced transaction data including fare information, to other systems and/or servers of the transit system for further processing.

In one embodiment, a method for enabling an item with a unique identifier to be used as fare media in a transit system is provided. The method can comprise receiving the unique identifier collected by a fare device of the transit system that indicates a transaction associated with the unique identifier. A first set of data can be created, including data associated with the unique identifier, a time value, and a physical location of the fare device in relation to the transit system. One or more rules for use in calculating a fare then can be chosen, and historical information associated with the unique identifier can be accessed. The historical information can have information regarding prior transactions associated with the unique identifier. The method can include calculating the fare based, at least in part, on the first set of data, the one or more rules, and the historical information. The historical information associated with the unique identifier can be updated to include information associated with the transaction, and a second set of data can be created. The second set of data can include information associated with the calculated fare.

Optionally, the additional information associated with the unique identifier can be accessed, where the additional information is a transit product, a transit user, and/or a value. Calculating the fare further can be based, at least in part, on this additional information. The additional information can include a value, and the value to reflect a payment of the fare can be updated. Additionally or alternatively, the transaction can be associated with a transit user entering the transit system, a transit user exiting the transit system, and/or a transit user passing from one physical location within the transit system to another physical location within the transit system.

Calculating the fare can occur after a decision has been made whether to allow a transit user passage at the fare device. Furthermore, lists can be used to determine whether to allow a transit user passage at the fare device, and the decision can be based, at least in part, on whether the unique identifier is found in a list.

Additionally or alternatively, the fare device can be at a first physical location, further comprising storing the first set of data at a second physical location before calculating the fare. The method can further comprise receiving a third set of data corresponding to a second transaction associated with the unique identifier where the second transaction is conducted after the first transaction. The third set of data can be stored at the second physical location and after the historical information is updated to include information associated with the first transaction, a fare associated with the third set of data can be calculated based, at least in part, upon the updated historical information.

Optionally, the choosing of the one or more rules can be based, at least in part, on the time value, the physical location of the fare device, or both. Additionally or alternatively, the item can comprise a payment card, an identification card, a mobile device, and/or a radio frequency identification (RFID) tag.

According to another embodiment, a system for enabling uniquely-identifiable media to be used as fare media transit is provided. The system can comprise a plurality of fare devices for conducting transactions in the transit system, where each fare device can have an input interface configured to receive a unique identifier from a media and a processing unit configured to create use data relating to a transaction. The use data can include data associated with the unique identifier, a time value, and a physical location of the fare device in relation to the transit system. Each fare device further can have a communication interface configured to transmit the use data to a server. The server can be communicatively coupled with the plurality of fare devices. The server can have a communication interface configured to receive the use data from at least one of the plurality of fare devices and a processing unit configured to choose a set of rules for use in calculating a fare associated with the transaction and access historical information associated with the unique identifier. The historical information can have information regarding prior transactions associated with the unique identifier. The processing unit further can calculate the fare based, at least in part, on the use data, the set of rules, and the historical information. The processing unit further can update the historical information associated with the unique identifier to include information associated with the transaction and create priced transaction data. The priced transaction data can include information associated with the calculated fare.

This embodiment can be altered in a variety of ways. For example, the system can include a central processing center communicatively coupled with the server and a database. The central processing center can be configured to receive the priced transaction data from the communication interface of the server and update data stored in the database based, at least in part, on the priced transaction data. Additionally or alternatively, a database can be communicatively coupled with the server. The database can be configured to store the historical information associated with the unique identifier.

Other variations on this embodiment are contemplated. The input interface of at least one of plurality of fare devices, for instance, can be configured to receive the unique identifier from a magnetic stripe, a bar code, a visible number or code, a radio frequency (RF) signal, and/or a biometric measurement. Additionally or alternatively, a data sequencing module can be communicatively coupled with the server and at least one of the plurality of fare devices. The data sequencing module can have a memory configured to store a plurality of use data corresponding to a plurality of transactions conducted by the at least one of the plurality of fare devices. The data sequencing module further can include a processing unit configured to analyze the plurality of use data stored in the memory and determine a sequence of the plurality of transactions corresponding with the plurality of use data. This sequence can indicate an order in which the plurality of transactions occurred. The data sequencing module further can include a communication interface configured to transmit the plurality of use data to the server in a manner that indicates the sequence of the plurality of transactions.

Yet another embodiment includes a machine-readable media with a set of instructions for enabling an item with a unique identifier to be used as fare media in a transit system. The instructions, when executed by at least one machine, can cause the at least one machine to receive the unique identifier collected by a fare device of the transit system. This receipt can indicate a transaction associated with the unique identifier. A first set of data can be created, including data associated with the unique identifier, a time value, and a physical location of the fare device in relation to the transit system. The instructions further can cause the at least one machine to choose one or more rules for use in calculating a fare and access historical information associated with the unique identifier. The historical information can have information regarding prior transactions associated with the unique identifier. The instructions further can cause the at least one machine to calculate the fare based, at least in part, on the first set of data, the one or more rules, and the historical information. The historical information associated with the unique identifier can be updated to include information associated with the transaction, and a second set of data can be created. The second set of data can have information associated with the calculated fare.

Various adjustments to this embodiment are contemplated. For instance, calculating the fare can occur after a decision has been made whether to allow a transit user passage at the fare device. Additionally or alternatively, if the fare device is at a first physical location, the instructions further can cause the at least one machine to store the first set of data at a second physical location before calculating the fare. Optionally, choosing the one or more rules can be based, at least in part, on the first set of data. Moreover, the unique identifier can comprise a primary account number associated with a payment card.

### BRIEF DESCRIPTION OF THE DRAWINGS

FIG. 1 is a block diagram of an embodiment of a transit system that can utilize a virtual fare card device in various transactions in the transit system.

FIG. 2 is a block diagram of an embodiment of a transit station system.

FIG. 3A is a block diagram of an embodiment of a physical fare device processing unit that can be used in various embodiments the transit system described herein.

FIG. 3B is a block diagram of an another embodiment of a physical fare device processing unit that can be used in various embodiments the transit system described herein.

FIG. 4A is a block diagram of a system using a virtual fare device, according to some embodiments.

FIG. 4B is a block diagram of another system using a virtual fare device, according to some embodiments.

FIG. 5A is a diagram of a method for using a virtual fare device to enable a uniquely-identifiable item as fare media in a transit system, according to some embodiments.

FIG. 5B is a diagram of an alternative method for using a virtual fare device to enable a uniquely-identifiable item as fare media in a transit system, according to some embodiments.

FIG. 6 is a swim-lane diagram of yet another method for using a virtual fare device to enable a uniquely-identifiable item as fare media in a transit system, according to some embodiments.

### DETAILED DESCRIPTION

In the following description, for the purposes of explanation, numerous specific details are set forth in order to provide a thorough understanding of various embodiments. It will be apparent, however, to one skilled in the art that various embodiments may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosed systems and methods as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Transactions at physical fare devices in a transit system, including transactions relating to a transit user's entry to and/or exit from the transit system or a transit user's passing from one location within the transit system to another location within the transit system, typically need to be quick, often 500 milliseconds or less. Stored-value fare media (e.g., fare media, such as a transit fare card and/or other smart card, that can store a value and historical information on the card) enables a physical fare device to conduct a transaction locally, retrieving information stored on the card to calculate a fare. Transactions using stored-value fare media therefore can be faster than transactions that would, for example, retrieve information from a remote source, such as a central database.

Using such stored-value fare media, however, has its limitations. For instance, if the stored-value fare media is lost or stolen, it can be difficult to remove the value from the lost or stolen stored-value fare media and restore it to a transit user. Additionally, because the storage capacity of a stored-value fare media can be limited, and because quick transactions times limit the amount of information that can be read and/or written to a stored-value fare media during a transaction, the amount of available information during such a transaction is limited. These limitations can further limit the transit services provider from providing multiple products associated with the stored-value fare media.

On the other hand, a transit system can be configured to enable a transit user to use any of a variety of uniquely-identifiable items as fare media. These items can include personal items such as identification or security cards, payment cards (e.g., bankcards (such as prepaid, credit, and/or debit cards), stored-value cards, fleet cards, charge cards, and other cards presented by a cardholder to make a payment), near-field-communication (NFC) enabled devices (such as NFC-enabled mobile phones, contactless payment cards, radio frequency identification (RFID) tags, etc.), media having bar codes or other visible numbers, codes, and/or images readable by laser and/or optical scanning, and even media conveying biometric information. The information collected by the physical fare device, described in more detail below, can include any information that can be used to uniquely identify the item storing the information. This unique identifier (hereafter “unique ID”) then can be used by physical fare devices to make an initial decision to allow or deny passage of a transit user at a point in the transit system.

The unique ID, along with other relevant information, can be transmitted to a “virtual” fare device, which can use the unique ID to access information stored on a database. This information can echo the type of information stored on a stored-value fare media, including fare cards, and can therefore act as a “virtual” fare card. However, limited transaction time and storage capacity, as described above, are not issues that would limit the functionality of the a virtual fare card. Additionally, the virtual fare device can output data similar to data sent from a physical fare device when the physical fare device transacts with traditional stored-value fare media. Thus, it can be easily integrated into a transit system. Furthermore, there is no necessity to write information onto the fare media because data needed for the fare calculation is stored elsewhere. The transit system therefore can have broad flexibility in enabling different types of uniquely-identifiable items as fare media, needing only to collect the unique ID from the item rather than write additional data to the item.

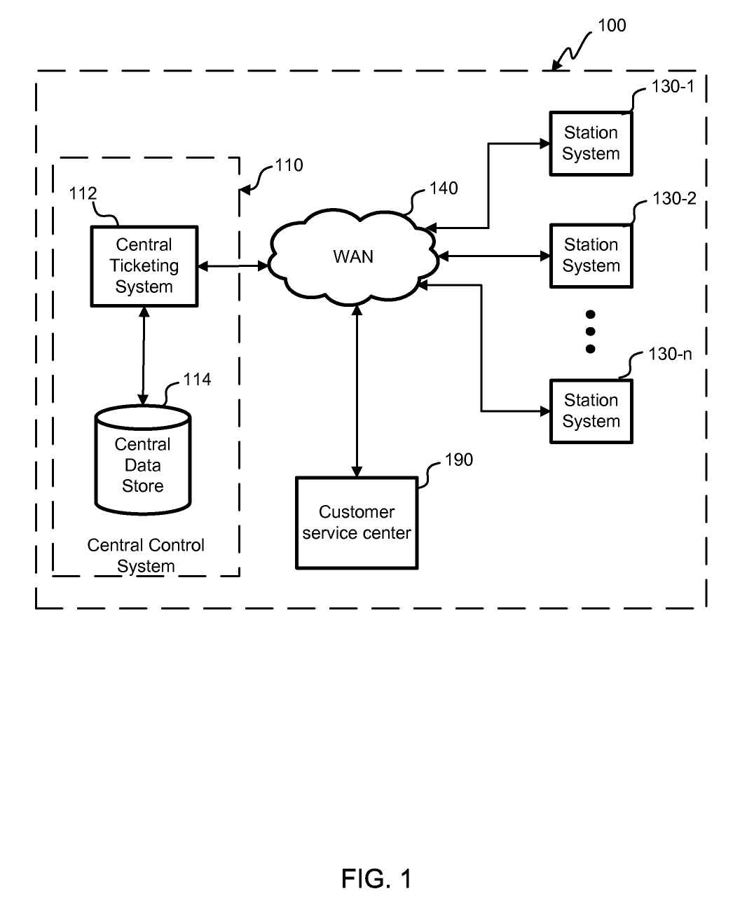

FIG. 1 illustrates a block diagram of an embodiment of a transit system 100 that can utilize the virtual fare device described herein. The transit system can include various forms of transit, including subway, bus, ferry commuter rail, para-transit, etc., or any combination thereof. It will be recognized that such a transit system 100 can be enabled for use in applications beyond transit, such as transportation systems (e.g., airline systems, car rental systems, etc.). The transit system 100 can provide for transit user accounts, which include information regarding a transit user. Moreover, a transit user account may be associated with the unique ID and/or virtual card information to facilitate processing and/or provide additional functionality to transit users. The transit user account can comprise information regarding a user of the transit system 100, such as a name, address, phone number, email address, user identification (such as a unique identifier of the user or other user ID), passcode (such as a password and/or personal identification number (PIN)), the unique ID, information regarding user preferences and user opt-in or opt-out selections for various services, product(s) associated with the transit user account, a value and/or credit associated with the product(s), information regarding a funding source 165 for the transit user account, and more.

The transit user account further can comprise funding and transaction information, such as product information, a funding source, and a payment amount. Moreover, a transit user may request a transit user account and provide the information contained therein by phone (such as a call to a customer service center 190 maintained and/or provided by the transit service provider of the transit system 100), on the Internet, at ticket booth, at a ticket vending machine, or by other means.

A central ticketing system 112 can comprise one or more servers and/or other computing systems having processors, memories, and network and/or other communication interfaces for processing and communicating information. The central ticketing system 112 can create a transit user account and/or virtual fare card, either or both of which can be stored and/or maintained on a database, such as a central data store 114 of a central control system 110. The central ticketing system 112 further can process transactions of transit system 100, compiling transactional data for the transit service provider and/or government agencies, reconciling with financial institutions, processing transactional data in accordance with governing regulations and/or laws, etc.

The central ticketing system's reconciliation with a funding source (not shown) may vary depending on one or more products associated with a fare media and/or transit user account, and the functionality desired by a transit services provider. For example, the transit user account and or virtual fare card may include a running balance mirroring a balance of the funding source. In such a case, transactions, such as passage of a user at a physical fare device (such as a turnstile, faregate, platform validator, para-transit vehicle, bus, conductor handheld unit, or fare box at a entry, exit, or other location of a transit station) can be recorded and/or tracked by the central ticketing system 112 and reconciled, on a per-transaction basis and/or collectively with other transactions. Along these lines, the central ticketing system 112 may reconcile payment for the transactions with the funding source as the transactions are received and/or on a scheduled basis, such as on an hourly or daily basis.

Additionally or alternatively, when transit products or services are associated with a transit user account and or virtual fare card, the central ticketing system 112 can draw funds from a funding source less frequently. For example, a transit product can include a certain number of rides or an unlimited number of rides for a certain period of time. In this case, the central ticketing system 112 can track transactions conducted at physical fare devices (e.g., transactions in the transit system associated with a ride), but may only need to reconcile with the funding source once, beforehand or afterward, for the purchase of the transit product.

Transactions of a user, such as passage at a physical fare devices, can frequently occur at stations of the transit system 100, although it will be understood that physical fare devices can exist elsewhere, such as on busses or trains. Station systems 130 can gather information regarding transactions and communicate the information to the central ticketing system 112 using a wide area network (WAN) 140. The WAN 140 can include one or more networks, such as the Internet, that may be public, private, or a combination of both. The WAN 140 could be packet-switched or circuit-switched connections using telephone lines, coaxial cable, optical fiber, wireless communication, satellite links, and/or other mechanisms for communication. Communication between the station systems 130 and the central control system 110 may be in real time or periodic. Thus, the usage of fare media throughout the transit system 100 can be tracked.

In the embodiment of FIG. 1, a central ticketing system 112 and a central data store 114 are shown for the central control system 110. As discussed above, central ticketing system 112 can receive periodic reports upon how credits or debits are being processed throughout the system 100. Additionally, changes in schedules, ticket prices, and delay notifications can be communicated from the central control system 112 to the station systems 130 via the WAN 140.

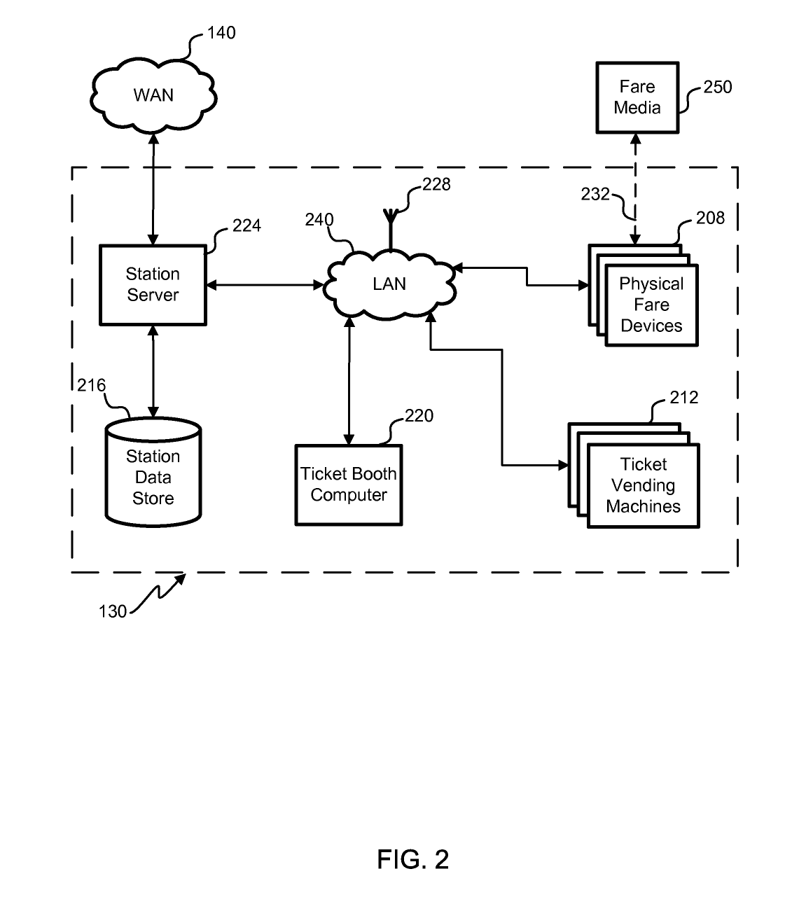

FIG. 2 shows a block diagram of an embodiment of a transit station system 130. As discussed above, transit system 100 can include various forms of transit, such as subway, bus, ferry, commuter rail, para-transit, and more. Because different forms of transit may require different functionality, various transit station systems 130 may have some or all of the components shown in the block diagram. A local area network (LAN) 240 can couple the various systems together and can include point-to-point connections, packet switched connections, wireless connections, and/or other networking techniques.

A station computer server 224 can be coupled to the WAN 140 to allow communication with the central ticketing system 112. Processing of local information can be performed on the station computer server 224. For example, fare information, schedule information, delay update information, and other transit related information can be processed at the computer server 224 and communicated to the various other machines in the transit system 100.

A ticket booth computer 220, physical fare devices 208, and transit vending machines (TVMs) 212 can communicate with the central ticketing system 112 through the station computer server 224 or directly with the central ticketing system 112 through LAN 240 or WAN 140 (e.g., the Internet). According to some embodiments, physical fare devices 208 collect information from a user at various locations in the transit station system 130, and can come in various forms such as turnstiles, faregates, platform validators, para-transit vehicles, busses, conductor handheld units, and/or fare boxes. The physical fare devices 208 can communicate with the station server 224 and/or central ticketing system 112 to determine whether to grant a user access when fare media has been presented at the physical fare devices 208. If physical fare devices communicate with a station server 224 during such transactions, the unique ID, which can be used to link a transaction with a transit user account and/or virtual fare card, may be stored on lists in the station data store 216. These lists can be updated on a regular basis to reflect other transactions of the fare media throughout the transit system 100. In other embodiments, similar lists of unique IDs of fare media 250 are stored at physical fare devices 208.

Physical fare devices 208 of the transit system 100 can be configured to read information from one or more sources of information on a fare media 250. To do so, physical fare devices 208 can employ one or more technologies, such as WIFI, BLUETOOTH®, bar-code and/or other optical scanning Physical fare devices 208 may also employ near-field communication (NFC) technologies to read information from RFID tags, NFC-enabled mobile devices (such as certain personal digital assistants (PDAs), mobile phones, and other portable and/or personal electronics), contactless payment cards, and other contactless devices.

The physical fare devices 208, TVMs 212, and one or more ticket booth computers 220, can communicate with the station server 224 via the LAN 204. This communication can be transmitted via a physical connection or wireless connection via one or more antennas 228. Transactions at physical fare devices 208, TVMs 212, and one or more ticket booth computers 220 can be communicated to the station server 224, stored at station data store 216, and/or transmitted to central ticketing system, which can process the transactions accordingly. As discussed in further detail below, the physical fare device 208 can recognize a transaction initiated by a fare media not having stored value (i.e., a fare media 250 for which a virtual fare device and/or virtual fare card will be used), and route the data associated with that transaction accordingly.

Various items can be used as fare media, whether or not the media is issued by a transit services provider. These items can include media such as identification cards, payment cards, personal electronic devices, bar codes and items having bar codes, NFC-enabled media, and more. NFC-enabled media can have a unique ID collected by physical fare devices 208 though NFC signals (e.g., radio frequency (RF) signals). By way of example, but not by limitation, such NFC-enabled media can include devices comprising RFID tags and/or RFID-tagged items, contactless payment cards (including but not limited to credit cards, prepaid cards, debit cards, or other bank cards or contactless smart cards.), contactless identification cards and/or fobs, and NFC-enabled mobile devices.

Depending on the type of item desired to be used as fare media 250, TVMs 212 may collect a unique ID of the item in one or more of a variety of ways, as discussed above. This can be done, for example, to authenticate an item as fare media 250, enabling it for use in transactions at fare devices of the transit system 100. The item does not have to be issued by a transit service provider in order to be authenticated as fare media 250 of the transit system, but the information collected by the TVM 212 (and subsequently by physical fare devices 208 in the transit system 100) may need to uniquely identify (e.g., contain a unique ID) the item to prevent misidentification of the item by the transit system 100. Once a TVM 212 collects the a unique ID from an item, the TVM 212 can communicate the unique ID and other information to systems, such as the central control system 110, for creating a virtual fare card and enabling the unique ID to be used as fare media 250 at physical fare devices 208 of the transit system 100. Thus, a transit user can use a TVM 212, to authenticate an item as fare media 250 and create a corresponding virtual fare card.

All or part of the information collected by a physical fare device 208 from fare media 250 can be used as a unique ID. This unique ID can comprise one or more fields of data including or based on information such as a name, a birth date, an identification number (such as a primary account number (PAN) associated with a payment card and/or financial account), a social security number, a drivers license number, a media access control (MAC) address, an electronic serial number (ESN), an international mobile equipment identifier (IMEI), a biometric measurement, and more. Because the unique ID is unique, it can be associated with a virtual fare card and/or transit user account, and utilized by a user at a TVM 212 to access and/or update information associated with the virtual fare card and/or transit user account.

In some instances, a unique ID may be assigned by a transit service provider and written to the fare media 250, such as an NFC-enabled mobile device. For example, a transit application running on an NFC-enabled cell phone can generate or otherwise provide a unique ID to be transmitted from the cell phone to physical fare devices 208 of the transit system 100. In other instances, a TVM 212 may also write a unique ID to the fare media 250. This can include writing to an unused portion of a memory integrated circuit chip file space on a smart card or an NFC component on the NFC-enabled mobile device, an unused track of a magnetic stripe, printing a bar code or other identifier on a media, etc.

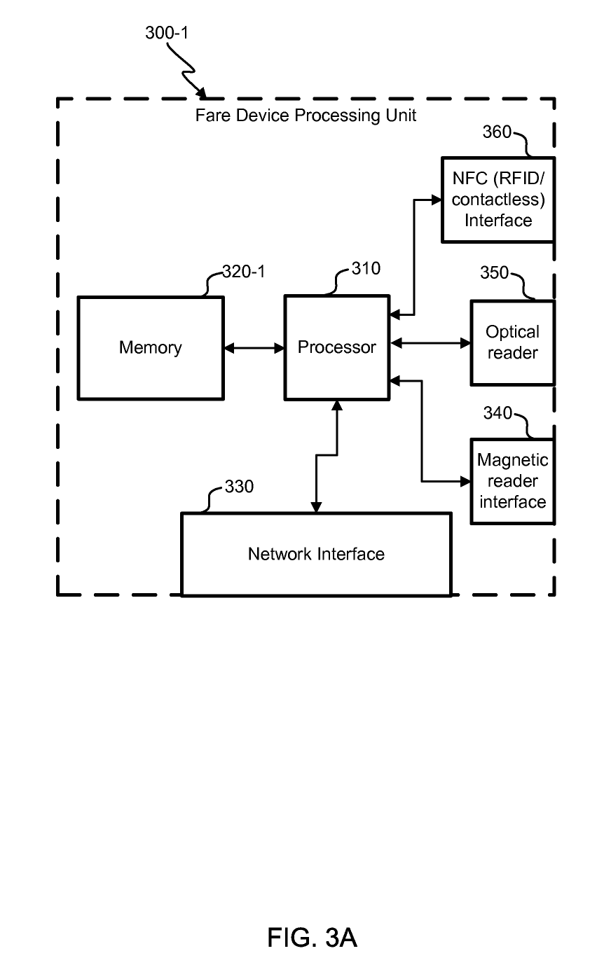

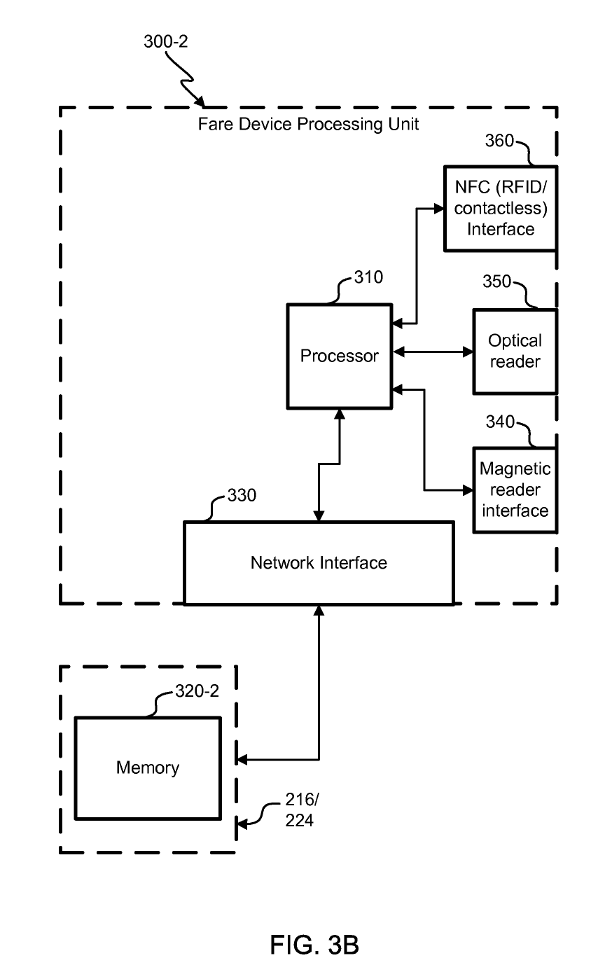

FIG. 3A is a simplified block diagram of an embodiment of an physical fare device processing unit 300-1, which can be coupled with and/or integrated into physical fare devices 208 of a transit system 100 and can control certain physical properties of physical fare devices 208 to allow or deny physical passage of a user at a location of the transit system 100. Interfaces such as an NFC interface 360 (which can read RFID and contactless card information, among others), optical reader 350, and/or magnetic reader interface 340, can be used to collect information from fare media 250, including the unique ID. The information can then be sent to the physical fare device processing unit 300-1.

In addition to performing any decryption and/or verifying any security features, the processor 310 can compare the unique ID against lists stored in memory 320-1 and/or other data store to determine whether to allow passage of the user at the physical fare device 208 or another physical location in the transit system 100. This can enable a physical fare device 208 to make a quick determination of whether to allow a transit user passage at a location in the transit system 100 without the need to communicate information to a remote device.

Lists, which can the unique ID and additional information such as a product associated with the unique ID, can be generated and maintained from a central system. This central system, such as the central ticketing system 112, can update lists on a regular basis to reflect other transactions of the fare media throughout the transit system 100. The central system can send updated list information to station server 224 via WAN 140 or directly with the central ticketing system 112 through WAN 140 (e.g., the Internet) or LAN 240. The station server 224 can store updated list at the station data store 216 and/or communicate the updated list information via LAN 240 to physical fare device processing unit 300-1, which can receive the information at network interface 330 and or store the list in memory 320-1. The physical fare device processing unit 300-1 can be coupled with an output interface (not shown), such as a display or audio speaker, to indicate when passage is allowed or denied, among other information.

Lists used by physical fare device processing units 300-1, station servers 224, and/or other devices in the transit system 100 for determining whether to allow passage of a transit user at a location in the transit system 100 can include one or more positive lists and/or negative lists. If, for example, the unique ID is found on the negative list, the processor 310 can determine to deny passage of the user. On the other hand, if the unique ID is found on a positive list, the processor 310 can determine to allow passage of the user. Additional rules may be implemented if the unique ID is found on both positive or negative lists, or is not found on any list. That said, it will be understood that precautions can be made to ensure that these two latter scenarios rarely happen.

The physical fare device processing unit 300 can perform different tasks depending on the type of different fare media 250 and/or information communicated from the fare media 250. For example, verifying a unique ID against lists, as described above, can be performed for all types of media. Alternatively, it can be performed only for fare media without stored-value information. Furthermore, for stored-value fare media, the processor 310 can utilize rules stored in memory 320-1 to calculate a fare associated with the transaction and utilize an interface 340, 350, 360 to deduct the fare from a value of the stored-value fare media. If a unique ID is properly verified, or if a transaction using stored-value fare media is successful, the processor 310 can cause the physical fare device processing unit 300-1 to physically allow or deny passage of a user at the physical fare device 208.

For successful transactions using stored-value fare media, the physical fare device processing unit 300-1 can further log priced transaction data relating to a successful transaction as in memory 320-1 and/or communicate the priced transaction data to a station server 224 and/or the central ticketing system 112 through a network interface 330. Depending on desired functionality and reporting requirements, the contents of the priced transaction data can vary. In general, however, it can include a unique ID of the stored-value fare media, the time of day, an identifier and/or location of the physical fare device 208, a change in value stored on the stored-value fare media, whether changing the value was successful (e.g., whether a write to the stored information was successful), and more.

If the physical fare device processing unit 300-1 recognizes that a fare media 250 without a stored value is used, it can perform a different process. For example, after the processor 310 checks the unique ID against lists stored in memory 320-1, rather than calculating a fare, the processor 310 simply can allow passage of the user and create use data for further processing of the transaction by a virtual fare device. The use data can contain information such as the unique ID, an identifier and/or location of the physical fare device (e.g., a station, bus route, train, fare zone, etc. in which the physical fare device is located), a transaction time, and/or other information that can be used in further processing of the transaction. The use data can then be transmitted to a station server 224 and/or the central ticketing system 112 through a network interface 330 at that time, or sometime thereafter.

FIG. 3B is a simplified block diagram of an alternative embodiment of a physical fare device processing unit 300-2. As illustrated, a memory 320-2, which can contain lists and/or list information as described above, may be located at a source external to physical fare device processing unit 300-2. The external source can include, for example, station server 224 or station data store 216. In such an embodiment, the processor 310 may communicate with the external source in deciding whether to allow or deny passage of a user at an physical fare device 208 and/or calculating a fare. Additionally or alternatively, the decision and/or fare calculation may be made by station server 224. In either case, it is desirable to make the decision quickly, often in a few hundred milliseconds or less. Thus, in this embodiment, it can be desirable that the connection between physical fare device processing unit 300-2 and the external source having memory 320-2 have sufficient speed and minimal latency to provide for a quick decision.

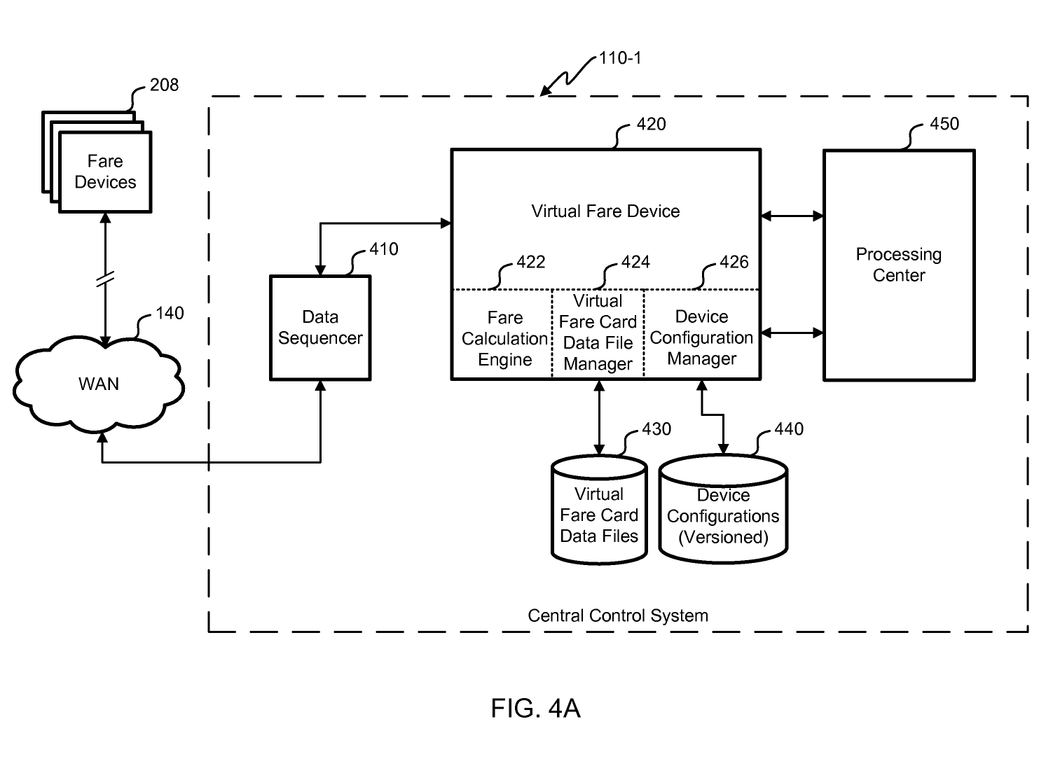

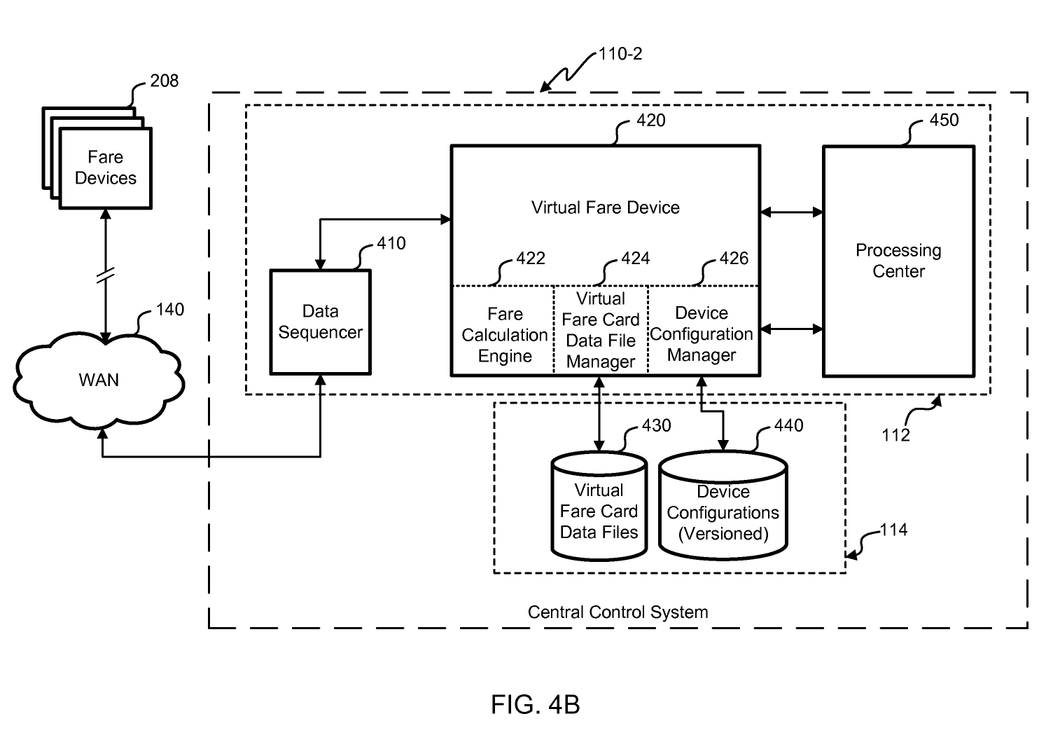

FIG. 4A is simplified block diagram of an embodiment of a virtual fare device 420 as utilized by a central control system 110-1. Alternative embodiments contemplate a virtual fare device implemented on one or more servers, computers, processing devices, and/or other systems of the transit system 100, which may or may not include the central control system 110-1. The virtual fare device 420 can be coupled with a data sequencer 410 and a processing center 450.

Because historical use data (including trip history) can be an essential part of calculating a fare correctly, data sequencer 410 can be used to help ensure the sequence of the use data is in the correct order before sending the data to the virtual fare device 420. The data sequencer 410 can comprise software and/or hardware components, such as processing and storage components (not shown) for storing and sequencing use data. The data sequencer 410 may further be a standalone device and/or unit having its own memory, processing capabilities, and communication interface, or may be integrated into another system of the transit system 100; and multiple data sequencers 410 may be used where a transit system 100 allows for such functionality. The use data can be sent from physical fare devices 208 to the data sequencer 410 directly or indirectly (e.g., through a station server 224, LAN 240, WAN 140, etc.), which can then store the use data for a set period of time before sending the use data to the virtual fare device 420.

It will be understood that physical fare devices can be configured to accept both fare media 250 with a unique ID as well as traditional stored-value fare media. For example, the physical fare device 208 can determine the fare media 250 is not a traditional stored-value fare media based on type of interface used to collect the unique ID, type of information collected and/or protocol used to sent and/or receive the information, etc. After recognizing the fare media 250 is not a traditional stored-value fare media, the fare device 208 can create make a determination whether to allow a transit user passage at the fare device 208 (or other location in the transit system 100), create the use data, and send the use data to the data sequencer 410. In so doing, the fare device may utilize a different application programming interface (API) than it would if it were sending priced transaction data for a transaction using traditional stored-value fare media.

According to some embodiments, the data sequencer 410 can store use data relating to a transaction made with a unique ID until it receives a use data relating to another transaction made with the same unique ID. Additionally or alternatively, the data sequencer can store the data for a set time, such as a certain amount of minutes or hours, before sending the use data to the virtual fare device 420. Moreover, the amount of time can vary depending on numerous factors such as time of day, or content of the use data (e.g., unique ID, time of transaction, identifier and/or location of the physical fare device 208). Embodiments further contemplate the data sequencer 410 sending use data to the virtual fare device 420 at a certain time and/or date (e.g., 2 A.M. on Thursdays, 12 A.M. on the last day of the month, etc.), regardless of the length of time the use data has been stored by the data sequencer 410. It will be understood that such rules governing the length of time that use data is stored by the data sequencer 410 can be based, among other things, on the functionality desired by the transit services provider and/or applicable transit routes of the transit system 100.

The data sequencer can be implemented in transit systems 100 where use data of transactions may be sent to a virtual fare device in an order that does not correspond to the order in which the associated transactions were conducted. For example, a transit user may use fare media 250 to conduct transit transactions on a bus of a transit system 100 followed by a train of the transit system 100, in a situation where the transit user typically would be charged a reduced fare due to the transfer from bus to train within a period of time. If the physical fare device 208 located on the bus communicates use data to a virtual fare device 420 after the physical fare device 208 on the train does, the virtual fare device 420 might incorrectly calculate the full fare for the transactions on the bus and the train without properly accounting for the transfer. On the other hand, if a data sequencer 410 is used, it can store the use data of the transaction on the train until after it receives the use data of the prior transaction on the bus. After receiving the use data of the transaction of the bus, the data sequencer 410 can send the use data of the transactions in order—use data for the transaction on the bus first, then the use data for the transaction on the train. Receiving the properly-sequenced use data then allows the virtual fare device to calculate the correct fare. In cases where use data for a subsequent transaction is not received (e.g., use data for an entry transaction is received, but not use data for a subsequent exit), the virtual fare device 420 can calculate a corresponding fare and/or flag a virtual fare card using system rules for such inconsistencies.

The virtual fare device can include various components. For example, the virtual fare device can include a fare calculation engine 422 for calculating a fare using the use data as well as device configuration and virtual fare card information. The device configuration information can be provided and/or updated by a device configuration manager 426, and stored on a device configuration database 440. The device configuration manager 426 can receive updates from a processing center 450, which can define the appropriate rules—included in the device configuration information—by which to calculate a fare. Such rules can take into account factors such as whether the transaction was associated with an exit from or an entry into the transit system, whether such an exit/entry was forced, a time of day, a product, and more. Device configuration information can be propagated by the processing center 450 to all physical fare devices 208, in addition to the virtual fare device 420. However, because the virtual fare device 420 may receive use data from transactions conducted prior to the device configuration update—the device configuration manager 426 can store previous device configuration versions in the device configuration database 440. This enables the virtual fare device 420 to use the applicable device configuration information in force at the time of the transaction. With this in mind, the virtual fare device 420 will extract transaction time and/or physical fare device location data from the use data to identify and apply the proper device configuration information in calculating a fare. This can help ensure that a fare calculated by a virtual fare device 420 will be the same as a fare calculated a physical fare device 208 at the time of the transaction.

A virtual fare card data file manager 424 can provide the virtual fare card information, which can be stored in virtual fare card data files 430. The virtual fare card information can comprise information that typically would be stored on a transit fare card or other stored-value fare media, such as a transit product and/or value, historical information, information regarding a transit user, and/or other information used in conducting transactions in the transit system 100. As mentioned above, because the virtual fare device 420 is not under the time constraints of a physical fare device 208, and because the physical memory of the virtual fare card data files 430 is not limited like a physical fare card, the information stored by the virtual fare card can include much more data than a stored-value fare media. Thus, the capabilities of a virtual fare card can be greater than those of a stored-value fare media. For instance, a virtual fare card may be able to support several products offered by the transit service provider, such as products related to parking, other transit systems 100, school and/or commuter products, regional products, etc., whereas a stored-value fare media may be limited to one or two products due to time and/or memory constraints.

With the device configuration and virtual fare card information, the virtual fare device 420 processes the use data in a manner similar to a transaction processed by a physical fare device 208. For instance, after the fare is calculated, as discussed above, a value associated with the virtual fare card may be adjusted in the amount of the fare. The historical information can be updated to include information regarding the fare calculation and/or use data.

Although the process can be similar to the process carried out by a physical fare device 208, there are several advantages to inherent to the virtual fare device 420. For example, the virtual fare device 420 and the virtual fare card do not run a risk of an “RF tear.” That is, because the transaction is virtualized, there is no risk of losing a data connection while a physical fare device 208 is attempting to write a value to a stored-value fare media. The transit system 100 therefore does not have to put into place contingency measures should an RF tear occur. More broadly, there is virtually no risk of write errors or incomplete transactions that can put transactions in an indeterminate state, result in revenue that cannot be claimed, require complicated correctional measures, and/or result in confusion for a transit user.

The control over the virtual fare cards, as opposed to stored-value fare media, provides added benefits. Having broad access to the virtual fare card at essentially any time, a transit service provider can make changes to transit products across the board. Moreover, corrections and/or changes to stored-value fare media that can be difficult (e.g., altering data fields or setting registered bits) are very manageable for virtual fare cards. This added control of virtual fare cards allows a transit service provider to make these corrections and/or updates in a safe, controlled manner.

The virtual fare device 420 additionally can generate priced transaction data and send the priced transaction data to the processing center 450. According to other embodiments, the processing center 450 can pull the priced transaction data from the virtual fare device 420 through polling, reading the data directly, etc. This data can include fare amount and whether the virtual fare card was successfully debited, similar to the priced transaction data generated by physical fare devices 208 for transactions using traditional stored-value fare media. Because the priced transaction data of the virtual fare device 420 is similar to that generated by physical fare devices 208, the virtual fare device 420 can be used with existing systems that interact with physical fare devices 208. In FIG. 4A, for example, the processing center 450 can be a central system that communicates, directly or indirectly, with physical fare devices 208 and one or more virtual fare devices 420 in the transit system. Because the virtual fare device 420 can provide information similar to physical fare devices 208, the processing center 450 requires little adjustment, if any, to communicate with the virtual fare device 420.

The interaction between the processing center 450 and the virtual fare device 420 can provide functionality beyond communicating priced transaction data and device configuration information, as discussed above. Information regarding the creation of new virtual fare cards, for example, may be communicated. Additionally or alternatively, the processing center 450 can further provide autoload instructions to the virtual fare device 420 in a manner similar to a physical fare device 208. The autoload instructions can include instructions to alter data of a virtual fare card associated with a unique ID to, for instance, add a product, modify a product, and/or modify a value associated the virtual fare card. Unlike a physical fare device 208 writing data to a stored-value fare media, the virtual fare device 420 does not have to wait for a transit user to present the stored-value fare media at the physical fare device 208. Instead, it can access the virtual fare card at any time to alter the data in accordance with the autoload instructions. Once the autoload instructions have been carried out, the virtual fare device 420 can provide a confirmation to the processing center 450 that the autoload was complete.

FIG. 4B is simplified block diagram of another embodiment of a virtual fare device 420 as utilized by a central control system 110-2. In this embodiment, various components are found in different systems within the central control system 110-2. For instance, the data sequencer 410, virtual fare device 420, and the processing center 450, are located within the central ticking system 112. In addition, the virtual fare card data files 430 and device configuration database 440 are found within the central data store 114. It will be understood that other embodiments are contemplated in which some or all of these components may be found in different systems and/or locations of the transit system 100.

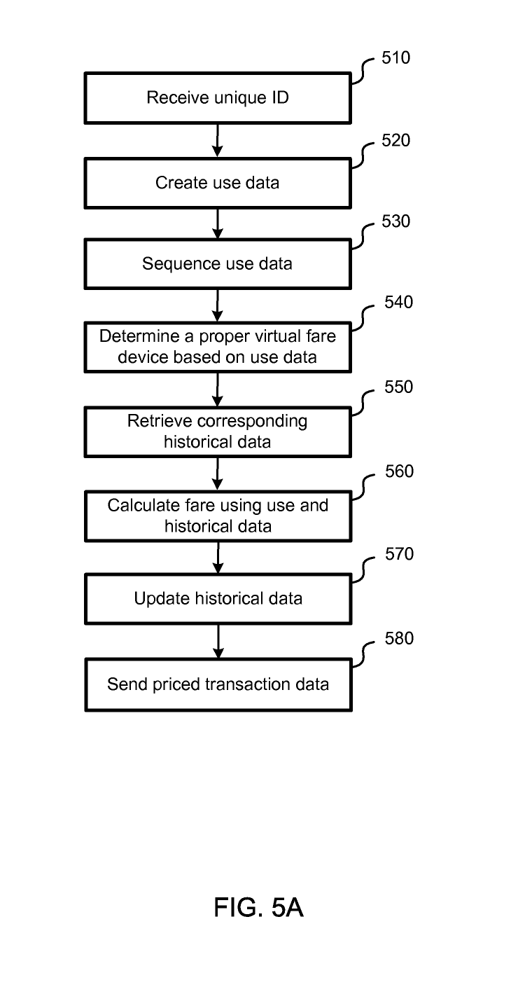

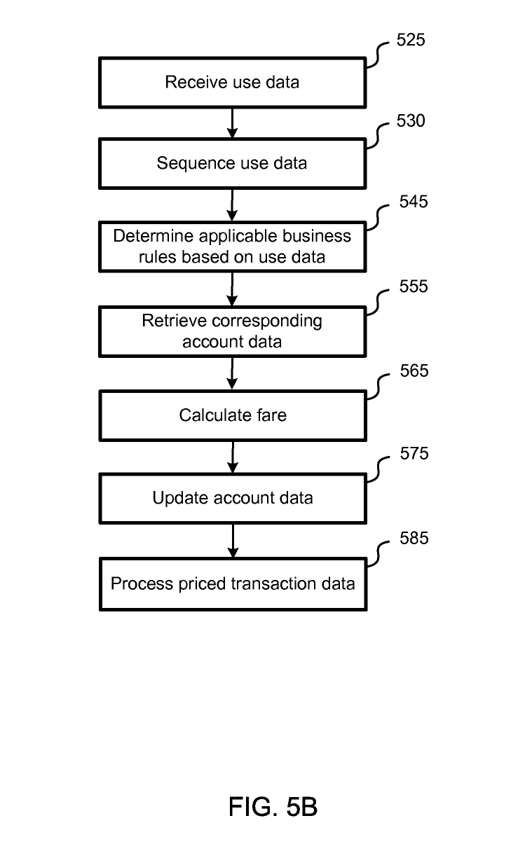

FIG. 5A is a diagram of a method for using a virtual fare device 420 to enable a uniquely-identifiable item as fare media in a transit system, according to some embodiments. Beginning at block 510, a unique ID is received. As indicated above, the unique ID may be received at a physical fare device 208 of the transit system 100, using any of a number of methods to collect the unique ID. Not by way of limitation, examples can include presenting a bar code, NFC-enabled item and/or device (such as a contactless payment card, NFC-enabled cell phone, RFID tag, etc.), biometric and/or media having a biometric measurement, magnetic-stripe card, etc. It can be noted that the physical fare device 208, as explained above, can use the unique ID to make a decision whether to allow a transit user passage at a location in the transit system 100 (e.g., at the location of the physical fare device 208). Thus any or all of blocks 520-580 can occur after the decision is made.

At block 520, use data is created. As explained above, the use data can include information—such as a location of a physical fare device 208, an identifier of the physical fare device 208, and/or a time of a transaction—that can be used in calculating a fare or other processing. The used data is then sequenced at block 530. Such sequencing can include storing the use data for a period of time, gathering additional use data, and ensuring that use data corresponding to two or more transactions associated with the unique ID are processed in a correct order. It will be understood that the storing could take place in one or more of many systems within the transit system 100, including locations remote from the physical fare device 208.

At block 540, the method includes determining a proper virtual fare device instantiation based on use data. For instance, as detailed above, fares may be calculated differently for different times and/or locations. Thus, an appropriate set of rules for making a correct fare calculation based on the time and/or location information of the use data can be determined.

At block 550, historical data is retrieved. As indicated above, historical data can be part of a virtual fare card, which may include other types of data in addition. At block 560, the fare is calculated using the use data and the historical data, and at block 570 the historical data is updated. The update can include information used in or resulting from the fare calculation, such as time, location, fare amount, etc. Finally, at block 580, priced transaction data may be sent. This can include all or part of the historical data as well as any additional data as required by systems for subsequent processing, reporting, and/or accounting.

FIG. 5B is a diagram of an alternative method for using a virtual fare device 420 to enable a uniquely-identifiable item as fare media in a transit system, according to some embodiments. This method can start with receiving use data at block 525, then sequencing the use data at block 530.

At block 545, the method includes determining applicable business rules based on use data. Similar to block 540 of FIG. 5A, this determination can be based on information contained in the use data, such as time and location of a transaction. Although a virtual fare device 420 of block 540 can implement business rules, block 545 suggests that the business rules may not necessarily be implemented by a virtual fare device, per se. It will be understood, for example, that the some or all of the processes performed by a virtual fare device as described herein may be performed by one or more other systems, devices, components, etc.

Echoing similar blocks in FIG. 5A, blocks 555, 565, and 575 include retrieving corresponding account data, calculating a fare, and updating account data, respectively. It can be noted that, as blocks 555 and 575 suggest, data used in calculating a fare (e.g., historical data associated with a unique ID) can be stored in an account. Although such an account may comprise a virtual fare card, it also can include additional information, such as transit user information and comprise and/or be associated with a transit user account as discussed above. Additional information included in a transit user account can be used by the transit system to provide features, products, and/or functionality that may not be specifically associated with fare calculation. Finally, at block 585, the priced transaction data associated with the use data can be processed.

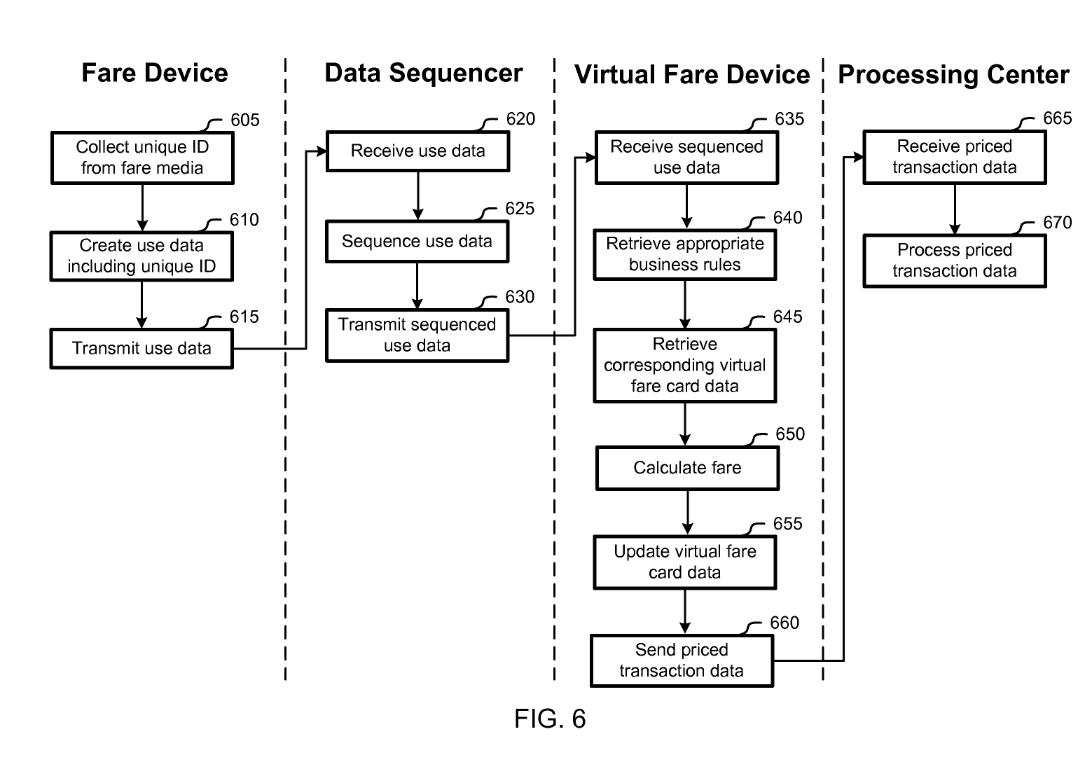

FIG. 6 is a swim-lane diagram of yet another method for using a virtual fare device to enable a uniquely-identifiable item as fare media in a transit system, according to some embodiments. This method associates various blocks with components of the transit system. For instance, at block 605, a physical fare device 208 can collect unique ID from fare media, and at block 610, the physical fare device can create use data including the unique ID.

At block 615, the physical fare device can transmit use data, which can be received by the data sequencer 410 at block 620. The data sequencer 410 can store the data for a period of time and/or reorder the use data to create sequenced use data that reflects a sequence of corresponding transactions (e.g., use data for an initial transaction is placed at an earlier position in the sequence than use data for a subsequent transaction).

At block 630, the data sequencer 410 can then transmit the sequenced use data, which can be received by a virtual fare device 420 at block 635. As discussed above, the data sequencer 410 and virtual fare device 420 can be integrated into a single physical system, such as a central ticketing system 112. Other embodiments contemplate one or more data sequencers 410 on separate physical systems than the virtual fare device 420, any of which can be implemented in various forms, such as one or more of hardware, software, firmware, middleware, etc. Moreover, data sequencer 410 and/or virtual fare device 420 may be functional components of a larger system comprising any combination of hardware, software, firmware, middleware, etc.

Having received the sequence use data, the virtual fare device 420, at block 640, can retrieve appropriate business rules for calculating a fare and/or conducting further processing of the sequenced use data. As discussed above, theses business rules can be determined based on the contents of the sequenced use data, such as location of the physical fare device 208 and/or time of the transaction (e.g., time at which the unique ID was collected by the physical fare device 208 at block 605). In certain embodiments, the virtual fare device 420 can comprise a program and/or method that can select and create a virtual fare device instance and/or data object having the same or similar device configuration as the physical fare device 208 at the time the physical fare device collected the unique ID at block 605.

At block 645, the virtual fare device 420 can retrieve virtual fare card data corresponding to the unique ID. As discussed above, the virtual fare card data can comprise historical data and/or other data that typically may be stored on stored-value fare media and used to calculate a fare. The virtual fare card data can be stored on one or more systems local and/or remote to the system on which the virtual fare device 420 is located. Once the fare is calculated, at block 650, the virtual fare card data can be updated, at block 655, to reflect the instant fare calculation and/or use data.

Priced transaction data, which can comprise data regarding the fare calculation and/or use data, then can be sent by the virtual fare device 420 at block 660 and received by a processing center 450 at block 665. The processing center 450 can then conduct further processing of the priced transaction data, at block 670. The processing center 450 can receive priced transaction data for all or a part of the transit system 100, including priced transaction data from transactions conducted by both physical fare devices 208 and virtual fare devices 420. Such processing can include using any or all of the data of the priced transaction data as necessary to satisfy regulatory requirements, process and settle transactions with financial institutions, update internal databases, and more. It will be understood that embodiments contemplated herein extend beyond the embodiment depicted in FIG. 6, having different components, more or less functional blocks, etc.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-readable instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

What is claimed is:

1. A system for enabling uniquely-identifiable media to be used as fare media in transit, the system comprising:
a plurality of fare devices for conducting transactions in the transit system, each fare device having:
an input interface configured to receive a unique identifier from a media;
a processing unit configured to create use data relating to a transaction, the use data including data associated with:
the unique identifier,
a time value, and
a physical location of the fare device in relation to the transit system; and
a communication interface configured to transmit the use data to a server; and
the server communicatively coupled with the plurality of fare devices, the server having:
a communication interface configured to receive the use data from at least one of the plurality of fare devices;
a processing unit configured to:
choose a set of rules for use in calculating a fare associated with the transaction;
access historical information associated with the unique identifier, the historical information having information regarding prior transactions associated with the unique identifier;
calculate the fare based, at least in part, on:
the use data,
the set of rules, and
the historical information,
update the historical information associated with the unique identifier to include information associated with the transaction; and
create priced transaction data, the priced transaction data including information associated with the calculated fare.

2. The system of claim 1 further comprising a central processing center communicatively coupled with the server and a database, the central processing center configured to receive the priced transaction data from the communication interface of the server and update data stored in the database based, at least in part, on the priced transaction data.

3. The system of claim 1, further comprising a database communicatively coupled with the server, the database configured to store the historical information associated with the unique identifier.

4. The system of claim 1, wherein the input interface of at least one of plurality of fare devices is configured to receive the unique identifier from at least one member of the group consisting of:
a magnetic stripe,
a bar code,
a visible number or code,
a radio frequency (RF) signal, and
a biometric measurement.

5. The system of claim 1, further comprising a data sequencing module communicatively coupled with the server and at least one of the plurality of fare devices, the data sequencing module having:
a memory configured to store a plurality of use data corresponding to a plurality of transactions conducted by the at least one of the plurality of fare devices; and
a processing unit configured to:
analyze the plurality of use data stored in the memory; and
determine a sequence of the plurality of transactions corresponding with the plurality of use data, the sequence indicating an order in which the plurality of transactions occurred;
a communication interface configured to transmit the plurality of use data to the server in a manner that indicates the sequence of the plurality of transactions.

6. A method for enabling an item with a unique identifier to be used as fare media in a transit system, the method comprising:
receiving the unique identifier collected by a fare device of the transit system, wherein said receiving indicates a transaction associated with the unique identifier;
creating a first set of data including data associated with:
the unique identifier,
a time value, and
a physical location of the fare device in relation to the transit system;
choosing one or more rules for use in calculating a fare;
accessing historical information associated with the unique identifier, the historical information having information regarding prior transactions associated with the unique identifier;
calculating the fare based, at least in part, on:
the first set of data,
the one or more rules, and
the historical information;
updating the historical information associated with the unique identifier to include information associated with the transaction; and
creating a second set of data, wherein the second set of data includes information associated with the calculated fare.

7. The method of claim 6, further comprising accessing additional information associated with the unique identifier, wherein the additional information is at least one of:
a transit product,
a transit user, or
a value.

8. The method of claim 7, wherein the calculating is further based, at least in part, on the additional information.

9. The method of claim 7, wherein the additional information includes a value, the method further comprising updating the value to reflect a payment of the fare.

10. The method of claim 6, wherein the transaction is associated with at least one member of the group consisting of:
a transit user entering the transit system,
a transit user exiting the transit system, or
a transit user passing from one physical location within the transit system to another physical location within the transit system.

11. The method of claim 6, wherein the calculating the fare occurs after a decision has been made whether to allow a transit user passage at the fare device.

12. The method of claim 11, wherein:
lists are used to determine whether to allow a transit user passage at the fare device; and
the decision is based, at least in part, on whether the unique identifier is found in a list.

13. The method of claim 6, wherein the fare device is at a first physical location, further comprising storing the first set of data at a second physical location before calculating the fare.

14. The method of claim 13, wherein the transaction comprises a first transaction, the method further comprising:
receiving a third set of data corresponding to a second transaction associated with the unique identifier, wherein the second transaction is conducted after the first transaction; and
storing the third set of data at the second physical location; and
calculating, after the historical information is updated to include information associated with the first transaction, a fare associated with the third set of data based, at least in part, upon the updated historical information.

15. The method of claim 6, wherein the choosing of the one or more rules is based, at least in part, on one or both of:
the time value, or
the physical location of the fare device.

16. The method of claim 6, wherein the item comprises at least one member of the group consisting of:
a payment card,
an identification card,
a mobile device, or
a radio frequency identification (RFID) tag.

17. A machine-readable media having a set of instructions for enabling an item with a unique identifier to be used as fare media in a transit system, the instructions, when executed by at least one machine, cause the at least one machine to:
receive the unique identifier collected by a fare device of the transit system, wherein said receiving indicates a transaction associated with the unique identifier;
create a first set of data including data associated with:
the unique identifier,
a time value, and
a physical location of the fare device in relation to the transit system;
choose one or more rules for use in calculating a fare;
access historical information associated with the unique identifier, the historical information having information regarding prior transactions associated with the unique identifier;
calculate the fare based, at least in part, on:
the first set of data,
the one or more rules, and
the historical information;
update the historical information associated with the unique identifier to include information associated with the transaction; and
create a second set of data having information associated with the calculated fare.

18. The machine-readable media of claim 17, wherein calculating the fare occurs after a decision has been made whether to allow a transit user passage at the fare device.

19. The machine-readable media of claim 17, wherein the fare device is at a first physical location and the instructions further cause the at least one machine to store the first set of data at a second physical location before calculating the fare.

20. The machine-readable media of claim 17, wherein choosing the one or more rules is based, at least in part, on the first set of data.

21. The machine-readable media of claim 17, wherein the unique identifier comprises a primary account number associated with a payment card.
